(19) United States
(12) Patent Application Publication
(10) Pub. No.: US 2026/0139744 A1
(43) Pub. Date: May 21, 2026

(54) PRESSURE CONTROL VALVE

(71) Applicants: Hyundai Motor Company, Seoul (KR); Kia Corporation, Seoul (KR); TAEKWANGFUJIKIN CO.,LTD, Busan (KR)

(72) Inventors: Jung Jun Park, Hwaseong-Si (KR); Hyeon Seong Kim, Hwaseong-Si (KR); Tae Woong Ahn, Busan (KR); Yong Ki Kim, Busan (KR); Woo Cheol Nam, Busan (KR)

(21) Appl. No.: 19/247,396

(22) Filed: Jun. 24, 2025

(30) Foreign Application Priority Data
Nov. 21, 2024 (KR) 10-2024-0167683

(51) Int. Cl. F16K 1/46; F17C 13/04

(52) U.S. Cl. CPC F16K 1/46; F17C 13/04; F17C 2205/0323; F17C 2205/0338; F17C 2221/012; F17C 2270/0168; F17C 2270/0184

(57) ABSTRACT

Disclosed is a pressure control valve including a valve body coupled to a valve coupling groove to be separable; a first gasket installed at a center portion of a front surface of the valve body, wherein the first gasket is configured to seal or unseal a pressurized gas passageway; and a second gasket provided on an outer surface of the valve body and pressed against an inner peripheral surface of the pressurized gas passageway.

### CROSS-REFERENCE TO RELATED APPLICATION

This application claims priority to Korean Patent Application No. 10-2024-0167683, filed in the Korean Intellectual Property Office on Nov. 21, 2024, the entire contents of which are incorporated herein by reference.

### TECHNICAL FIELD

The present disclosure relates to a pressure control valve.

### BACKGROUND

A fuel cell electric vehicle (FCEV) is capable of generating electric energy through an electrochemical reaction of oxygen and hydrogen in a fuel cell stack, which is its power source.

A plurality of high-pressure hydrogen containers for storing high-pressure hydrogen gas may be provided in the fuel cell vehicle, and hydrogen may be injected into the high-pressure hydrogen containers via a hydrogen fuel line of the hydrogen storage system. The hydrogen stored in the high-pressure hydrogen container in this manner may be decompressed through a regulator and supplied via the hydrogen supply line to the fuel cell stack to generate electrical energy needed to power the vehicle.

In addition, the fuel cell vehicles may be provided with a receptacle for fueling hydrogen. The receptacle may be a type of a connector that connects to a fueling nozzle that supplies the hydrogen gas. The hydrogen supplied through the receptacle may be stored in the high-pressure hydrogen container through a manifold. In addition, the manifold may be provided with a check valve for controlling the supply of the hydrogen supplied along the hydrogen fuel line of the hydrogen storage system.

Immediately after the high-pressure hydrogen container is filled with hydrogen, internal pressures of the hydrogen fueling line that connects the receptacle to the manifold may be maintained at a high pressure (e.g., 700 bar).

However, the solenoid valve provided at an inlet of the high-pressure hydrogen container of the hydrogen supply line may be of a normal closed type, whose default behavior when electric power has been shut off is to block the passage. Thus, it may be difficult or impossible to release the pressure inside the high-pressure pipeline (e.g., fuel line) when the electric power is cut off unexpectedly. Accordingly, it may be necessary to establish a control strategy to construct a hydrogen emission (e.g., release) sequence through re-establishing the electric power supply, or to establish a pressure release method if it is impossible to supply electric power or if the electric power is available but the valve system is inoperable mechanically.

In addition, in at least some implementations of the hydrogen storage system of a fuel cell vehicle without a solenoid valve, a more than necessary amount of gas may need to be released to lower the pressure of a high-pressure fuel line even when only parts of the high-pressure pipeline requires maintenance.

### SUMMARY

The present disclosure has been made to solve the above-mentioned problems occurring in the prior art while advantages achieved by the prior art are maintained intact.

An aspect of the present disclosure provides a pressure control valve that may mechanically release a pressure in a high-pressure pipeline when electric power to a hydrogen storage system is abnormally cut off to discharge high-pressure hydrogen in the pipeline.

An aspect of the present disclosure also provides a pressure control valve that may secure airtightness dually by installing seal members on a front surface and a rear surface of a valve body, respectively.

Objects of the present disclosure are not limited to the above-mentioned object, and other objects and advantages of the present disclosure that is not mentioned will be understood from the following description, and it will be apparently understood from one or more example embodiments of the present disclosure. In addition, it will be easily understood that the objects and advantages of the present disclosure are realized by means and combinations described in the appended claims.

According to one or more example embodiments of the present disclosure, a pressure control valve may include: a valve body coupled to a valve coupling groove to be separable; a first gasket installed at a center portion of a front surface of the valve body; and a second gasket provided on an outer surface of the valve body and pressed against an inner peripheral surface of the pressurized gas passageway. The first gasket may be configured to seal or unseal a pressurized gas passageway.

The valve coupling groove may include: a first groove portion that is tapered such that a diameter of a groove of the first groove portion decreases towards a tip end of the first groove portion, and a second groove portion extending in parallel to the first groove portion toward a rear end of the valve coupling groove and having a first screw thread on an inner surface of the second groove portion.

The valve body may include: a step transitioning from a first portion, having a first diameter and coupled to the first groove portion, to a second portion, coupled to the second groove portion and having a second diameter greater than the first diameter.

A tip end of the first portion may be tapered, and the first diameter of the first portion may decrease towards a front side.

A discharge hole, formed to be recessed from the step of the valve body to a rear end of the valve body, may be provided.

A recess may be formed at a center portion of a rear surface of the valve body. The recess may be configured to receive a tip of a fastening tool.

The pressure control valve may further include a snap ring installed in the valve coupling groove and attached to a rear surface of the valve body. The snap ring may be configured to prevent the pressure control valve from deviating from the valve coupling groove.

A ring coupling groove, to which the snap ring is coupled, may be formed on an inner circumferential surface of the valve coupling groove.

The first gasket may be spherical.

The first gasket may be configured to elastically deform to press against and create a seal around the pressurized gas passageway. A corresponding surface of the first gasket may be formed in a planar shape.

The second gasket may be attached to a front surface of the step. The second gasket may include an elastic material having an annular cross-sectional shape formed along the outer surface of the valve body.

The second gasket may extend along a lengthwise direction thereof, and include a plurality of slots through which pressurized hydrogen flows.

The plurality of slots may be provided around the step.

The valve coupling groove may be a valve coupling groove of a regulator. The regulator may include hydrogen.

According to one or more example embodiments of the present disclosure, a hydrogen storage system may include: a regulator; and a pressure control valve. The pressure control valve may include: a valve body coupled to a valve coupling groove to be separable; a first gasket installed at a center portion of a front surface of the valve body; and a second gasket provided on an outer surface of the valve body and pressed against an inner peripheral surface of the pressurized gas passageway. The first gasket may be configured to seal or unseal a pressurized gas passageway.

### BRIEF DESCRIPTION OF THE DRAWINGS

The above and other objects, features and advantages of the present disclosure will be more apparent from the following detailed description taken in conjunction with the accompanying drawings:

FIG. 1 is a cross-sectional view illustrating a pressure control valve;

FIG. 2 is a rear view illustrating a pressure control valve;

FIG. 3 is a view illustrating a first seal member of a pressure control valve;

FIG. 4 is a view illustrating a second seal member of a pressure control valve; and

FIG. 5 is a view illustrating a closed state of a pressure control valve.

### DETAILED DESCRIPTION

Hereinafter, one or more example embodiments of the present disclosure will be described in detail with reference to the accompanying drawings. In adding reference numerals to the components of the drawings, it should be noted that the same components have the same numerals as possible even when they are illustrated on different drawings. In describing the example embodiments of the present disclosure, detailed descriptions associated with well-known functions or configurations will be omitted if they may make subject matters of the present disclosure unnecessarily obscure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Furthermore, in describing components of one or more example embodiments of the present disclosure, the terms first, second, A, B, (a), (b), and the like may be used herein. These terms are only used to distinguish one component from another component, but do not limit the corresponding components irrespective of the nature, order, or priority of the corresponding components. When it is described that a certain component is “connected to”, “coupled to” or “electrically connected to” a second component, it should be understood that the component may be directly connected or electrically connected to the second component, but a third component may be “connected”, “coupled” or “electrically connected” between the components.

Hereinafter, a pressure control valve 200 will be described in detail with reference to the accompanying drawings.

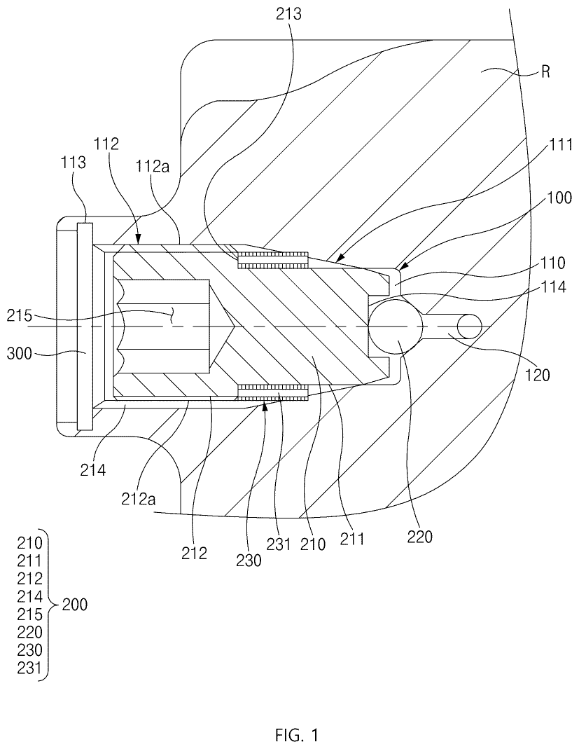

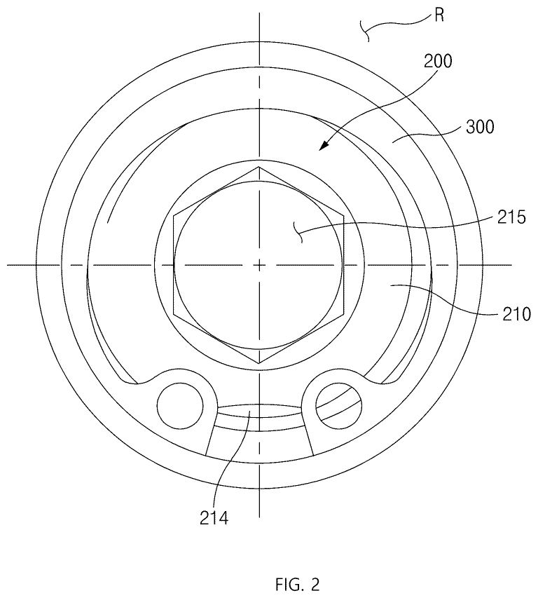

FIG. 1 is a cross-sectional view illustrating the pressure control valve 200, and FIG. 2 is a rear view illustrating the pressure control valve 200.

The pressure control valve 200 may mechanically release a pressure in a regulator “R” if electric power to the hydrogen storage system is abnormally (e.g., unexpectedly) cut off.

Referring to FIG. 1, a valve coupling groove (also referred to as a valve coupling groove part) 100 may be provided in a high-pressure passage (also referred to as a pressurized gas passageway) 120 of the regulator “R”, in which the pressure control valve 200 is installed.

The valve coupling groove 100 may be formed as a circular slot 110 having a specific depth when viewed from a rear side. Here, the depth may correspond to a length of the valve body 210 of the pressure control valve 200.

The slot 110 of the valve coupling groove 100 may be formed having a first part (also referred to as a first portion or an inner portion) 111 that formed in a tapered shape, in which a diameter of a groove decreases as it goes toward a tip end thereof, and a second part (also referred to as a second portion or an outer portion) 112 having a circular cross-sectional shape that extends in parallel from the first part 111 toward a rear end thereof.

A high-pressure passage (also referred to as a pressurized gas passageway) 120, through which high-pressure hydrogen flows toward the valve coupling groove 100, extends on a front side of the first part 111. Furthermore, a first screw thread (also referred to as a first screw portion or a first screw part) 112a may be formed on an inner surface of the second part 112 to be screw-coupled to the pressure control valve 200.

The pressure control valve 200 may include a valve body 210, a first seal member (e.g., a gasket) 220, and a second seal member (e.g., a gasket) 230.

The valve body 210 may be selectively coupled to or decoupled from the valve coupling groove 100. The valve body 210 may include a first coupling part (also referred to as a first portion, a first cylinder, a first coupler, etc.) 211 that is inserted into and coupled to the first part 111 of the valve coupling groove 100. The valve body 210 may further include a second coupling part (also referred to as a second portion, a second cylinder, a second coupler, etc.) 212 that is inserted into and coupled to the second part 112.

The first coupling part 211 corresponds to a front side of the valve body 210, and the second coupling part 212 corresponds to a rear side of the valve body 210.

The first coupling part 211 of the valve body 210 may be formed to have a small-diameter portion that is smaller than that of the second coupling part 212. The second coupling part 212 may include a stepped part (also referred to as a step, a transition, an indentation, an indented portion, etc.) 213 that is formed to have a large-diameter portion that is larger than that of the first coupling part 211.

Accordingly, the first coupling part 211 with the small-diameter portion may be inserted into the first part 111 having the taper shape, in which the diameter of the groove decreases as it goes toward the tip end, and the second coupling part 212 with the large-diameter portion may be coupled to the second part 112 that extends in parallel from the first part 111 toward the rear end.

When the pressure control valve 200 is inserted into the valve coupling groove 100, the tip end of the first coupling part 211 may be formed in a taper shape, a diameter of which decreases as it goes toward the front side so that the pressure control valve 200 is easily inserted into the valve coupling groove 100.

In this case, a second screw thread (also referred to as a second screw portion or a second screw part) 212a that is coupled to the first screw thread 112a of the second part 112 may be formed on an outer surface of the second coupling part 212. Accordingly, the pressure control valve 200 may be screw-coupled to the valve coupling groove 100. Furthermore, a discharge hole 214 that is formed to be recessed from the stepped part 213 to a rear end and allows high-pressure hydrogen that flows from the high-pressure passage 120 to be discharged between the valve coupling groove 100 and the pressure control valve 200 when the pressure control valve 200 is decoupled from the valve coupling groove 100 may be formed on an outer surface of the valve body 210.

As illustrated in FIG. 2, a tool insertion recess part (also referred to as a recess, a cavity, etc.) 215, to which a fastening tool, such as a wrench, is coupled (e.g., inserted), is formed on a rear surface of the valve body 210. The tool insertion recess part 215 is formed in a hexagonal recess shape, and is easily coupled or decoupled by fastening or releasing the valve body 210 along the screw threads 112a and 212a of the valve coupling groove 100 by using a fastening tool, such as a hexagonal wrench. The hexagonal recess shape of the tool insertion recess part 215 may be changed as necessary.

A snap ring 300 that is closely attached to the rear surface of the valve body 210 of the pressure control valve 200 and has a stopper function may be installed in the valve coupling groove 100 so that the pressure control valve 200 coupled to the slot 110 of the valve coupling groove 100 is prevented from deviating from the valve coupling groove 100.

A ring coupling groove 113, to which the snap ring 300 is coupled, is formed on the inner circumferential surface of the slot 110 of the valve coupling groove 100.

A distance between a tip end of the slot 110 of the valve coupling groove 100 and the ring coupling groove 113, to which the snap ring 300 is coupled, may correspond to a length of the pressure control valve 200.

When the pressure control valve 200 is completely coupled to the slot 110 of the valve coupling groove 100, the rear surface of the pressure control valve 200 may correspond to the ring coupling groove 113. Accordingly, when the snap ring 300 is coupled to the ring coupling groove 113, the pressure control valve 200 is prevented from being separated from the valve coupling groove 100 by the high-pressure hydrogen of 700 bar discharged through the high-pressure passage 120 of the regulator “R”. The snap ring 300 may be removed from the ring coupling groove 113 through a tool, such as a nipper, and it is important to make an inner diameter of the snap ring 300 smaller than an outer diameter of the valve body 210 so that the valve body 210 is prevented from being separated from the valve coupling groove 100. The snap ring 300 may be used when the coupling state is not complete due to wear or plastic deformation of the first screw thread 112a of the valve coupling groove 100 and the second screw thread 212a of the valve body 210.

A first seal member (e.g., gasket) 220 that is closely attached to the high-pressure passage 120 to secure airtightness of the high-pressure passage 120 may be installed at a center of a front surface of the valve body 210, and a seal member installation part 114 for seating the first seal member 220 on the valve body is formed. The seal member installation part 114 is formed in a groove shape that is recessed such that the first seal member 220 is mounted therein.

The first seal member 220 may be mounted on the seal member installation part 114 to selectively open and close the high-pressure passage 120 when the valve body 210 is coupled to or decoupled from the valve coupling groove 100.

Here, the first seal member 220 may be formed in a ball shape (e.g., spherical), but the present disclosure is not limited thereto, and any shape may be variously applied without limitation as long as it may block the high-pressure passage 120. Here, the first seal member 200 may be formed of a metal material or an elastic material, such as rubber (EPDM, NBR, or the like) or plastic (PEEK, PAI, PI, or the like).

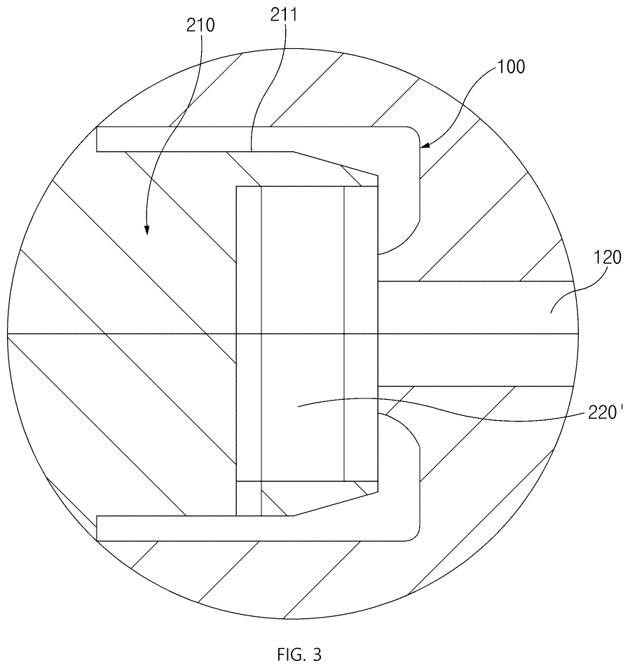

FIG. 3 illustrates another configuration of the first seal member 220 of the pressure control valve 200.

The first seal member 220′ may be formed of an elastic material having elasticity, such as rubber or plastic. The first seal member 220′ may have a shape that may form a surface pressure with the high-pressure passage 120 to ensure a good contact while closely contacting the high-pressure passage 120 when the valve body 210 is inserted into the valve coupling groove 100.

That is, a corresponding surface of the first seal member 220′ may have a planar shape, by which airtightness may be secured as it is elastically deformed while being pressed against the high-pressure passage 120. However, the present disclosure is not limited thereto, and any shape capable of securing airtightness may be variously applied without limitation as long as it may secure airtightness.

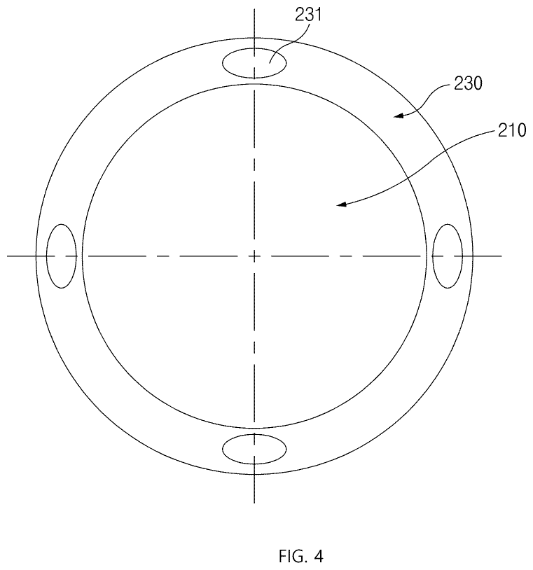

FIG. 4 is a view illustrating the second seal member (e.g., gasket) 230 of the pressure control valve 200.

Like the first seal member 220 formed of an elastic material, the second seal member 230 may be formed of an elastic material having elasticity, such as rubber or plastic.

The second seal member 230 is closely attached to a front surface of the stepped part 213 that is located on the outer surface of the valve body 210, and has an annular cross-sectional shape that is formed along the outer surface of the valve body 210.

A plurality of slots 231 that are formed long along a lengthwise direction of the second seal member 230 are formed in the second seal member 230.

A plurality of slots 231 may be formed on upper, lower, left, and right sides of the second seal member 230, respectively, but may be applied without limitation. The plurality of slots 231 may be flow spaces, in which high-pressure hydrogen introduced into the valve coupling groove 100 through the high-pressure passage 120 may flow toward the rear side of the valve body 210. The slots 231 may be provided on an outside of the stepped part 213 to secure flow spaces for high-pressure hydrogen that flows between the valve coupling groove 100 and the valve body 210.

The slot 231 may have a circular shape or an oval shape, but the present disclosure is not limited thereto, and a polygonal shape may be adopted.

The first part 111 of the valve coupling groove 100 is formed as a tapered inclined surface, and an area of the space, in which the second seal member 230 is located, may be changed as the first coupling part 211 of the valve body 210 are moved forward and rearward.

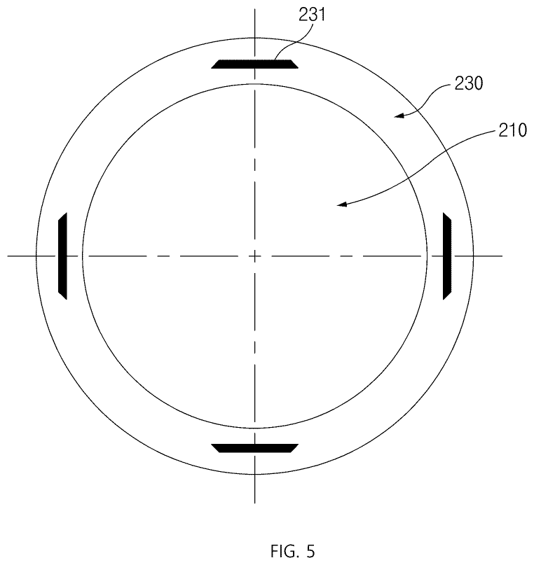

FIG. 5 is a view illustrating a closed state of the pressure control valve 200, and when the first coupling part 211 of the valve body 210 is moved forward along the valve coupling groove 100 while the second coupling part 212 of the valve body 210 is screw-coupled to the second part 112 of the valve coupling groove 100, the second seal member 230 installed on an outer surface of the first coupling part 211 is pressed against the tapered inclined surface of the first part 111 of the valve coupling groove 100 and thus, the pressure control valve 200 is in a closed state. In this case, facing surfaces of the plurality of slots 231 of the second seal member 230 also are pressed.

That is, when the valve body 210 is moved forward along the valve coupling groove 100 and the first seal member 220 surface-contacts the high-pressure passage 120, the slots 231 also are pressed at the same time when the second seal member 230 is pressed against the tapered inclined surface of the first part 111 of the valve coupling groove 100 so that airtightness of the high-pressure hydrogen that flows through a aperture between the valve coupling groove 100 and the valve body 210.

On the other hand, when the first coupling part 211 is moved rearward from the valve coupling groove 100 while the second coupling part 212 of the valve body 210 is decoupled from the second part 212 of the valve coupling groove 100, the second seal member 230 together with the slots 231 is restored to an original state while the area of the space, in which the second seal member 230 is located, is expanded, so that the pressure control valve 200 is in an opened state (see FIG. 4).

Accordingly, because the flow space, in which the high-pressure hydrogen may flow, is secured while the slots 231 of the second seal member 230 are opened, the high-pressure hydrogen may be discharged through the discharge hole 214.

In this way, according to the present disclosure, the pressure control valve 200 that may discharge high-pressure hydrogen in the regulator “R” by excluding a valve (e.g., a conventional solenoid valve or any other valve) that may not be drive, and instead, by mechanically releasing the pressure in a high-pressure pipeline of the regulator “R” when electric power is abnormally cut off due to a short circuit.

According to an aspect of the present disclosure, a pressure control valve coupled to a valve coupling groove part of a regulator, which a high-pressure passage meets includes a valve body coupled to the valve coupling groove part to be separable, a first seal member installed at a center of a front surface of the valve body, and for selectively opening and closing the high-pressure passage, and a second seal member provided on an outer surface of the valve body, and pressed against an inner peripheral surface of the high-pressure passage.

The valve coupling groove part may include a first part formed in a taper shape, of which a diameter of a groove decreases as it goes a tip end thereof, and a second part extending in parallel from the first part toward a rear end and having a first screw portion on an inner surface thereof.

The valve body may include a stepped part having a first coupling part having a small-diameter portion coupled to the first part, and a second coupling part coupled to the second part and having a large-diameter portion being larger than the first coupling part.

A tip end of the first coupling part may be formed in a taper shape, a diameter of which decreases as it goes toward a front side.

A discharge hole formed to be recessed from the stepped part of the valve body to a rear end of the valve body may be provided.

A tool insertion recess part, to which a fastening tool is coupled, may be formed at a center of a rear surface of the valve body.

A snap ring closely attached to a rear surface of the valve body and having a stopper function may be installed in the valve coupling groove part.

A ring coupling groove, to which the snap ring is coupled, may be formed on an inner circumferential surface of the valve coupling groove part.

The first seal member may be formed in a ball shape.

The first seal member may be elastically deformed when being pressed against the high-pressure passage to secure airtightness, and a corresponding surface thereof may be formed in a planar shape.

The second seal member may be closely attached to a front surface of the stepped part, and may be formed of an elastic material having an annular cross-sectional shape formed along an outer surface of the valve body.

The second seal member may be formed long along a lengthwise direction thereof, and may include a plurality of slots as a flow space of high-pressure hydrogen.

The slot may be provided on an outside of the stepped part.

According to the pressure control valve according to the present disclosure of the above-described configuration, the high-pressure hydrogen in the regulator may be stably discharged by mechanically releasing the pressure in the regulator when the electric power to the hydrogen storage system is abnormally cut off.

The airtightness for preventing leakage of the high-pressure hydrogen may be secured by the first seal member that selectively opens and closes the high-pressure passage in the regulator, in which the high-pressure hydrogen flows, and the second seal member that is pressed against on the inner peripheral surface of the high-pressure passage.

When the valve is released, the safety of the operator may be secured by forming the annular ring coupling groove in the valve installation groove part and installing the snap ring in the ring coupling groove to eliminating an element that damages the safety of the operator while the valve body is released at once during a release operation.

The above-mentioned description of the present disclosure is intended to be illustrative, and it should be understood by those skilled in the art that the present disclosure may be embodied in other specific forms without departing from the spirit or essential characteristics thereof. Therefore, the above-described embodiments are examples in all aspects, and should be construed not to be restrictive. The scope of the present disclosure is defined by claims to be described below, and it should be interpreted that the scopes or claims of the present disclosure and all modifications or changed forms derived from the equivalent concept are included in the scopes of the present disclosure.

What is claimed is:

1. A pressure control valve comprising:
a valve body coupled to a valve coupling groove to be separable;
a first gasket installed at a center portion of a front surface of the valve body, wherein the first gasket is configured to seal or unseal a pressurized gas passageway; and
a second gasket provided on an outer surface of the valve body and pressed against an inner peripheral surface of the pressurized gas passageway.

2. The pressure control valve of claim 1, wherein the valve coupling groove comprises:
a first groove portion that is tapered such that a diameter of a groove of the first groove portion decreases towards a tip end of the first groove portion, and
a second groove portion extending in parallel to the first groove portion toward a rear end of the valve coupling groove and having a first screw thread on an inner surface of the second groove portion.

3. The pressure control valve of claim 2, wherein the valve body comprises:
a step transitioning from a first portion, having a first diameter and coupled to the first groove portion, to a second portion, coupled to the second groove portion and having a second diameter greater than the first diameter.

4. The pressure control valve of claim 3, wherein a tip end of the first portion is tapered, and the first diameter of the first portion decreases towards a front side.

5. The pressure control valve of claim 4, wherein a discharge hole, formed to be recessed from the step of the valve body to a rear end of the valve body, is provided.

6. The pressure control valve of claim 5, wherein a recess is formed at a center portion of a rear surface of the valve body, wherein the recess is configured to receive a tip of a fastening tool.

7. The pressure control valve of claim 2, further comprising a snap ring installed in the valve coupling groove and attached to a rear surface of the valve body, wherein the snap ring is configured to prevent the pressure control valve from deviating from the valve coupling groove.

8. The pressure control valve of claim 7, wherein a ring coupling groove, to which the snap ring is coupled, is formed on an inner circumferential surface of the valve coupling groove.

9. The pressure control valve of claim 1, wherein the first gasket is spherical.

10. The pressure control valve of claim 1, wherein the first gasket is configured to elastically deform to press against and create a seal around the pressurized gas passageway, and wherein a corresponding surface of the first gasket is formed in a planar shape.

11. The pressure control valve of claim 3, wherein the second gasket is attached to a front surface of the step, and wherein the second gasket comprises an elastic material having an annular cross-sectional shape formed along the outer surface of the valve body.

12. The pressure control valve of claim 11, wherein the second gasket extends along a lengthwise direction thereof, and comprises a plurality of slots through which pressurized hydrogen flows.

13. The pressure control valve of claim 12, wherein the plurality of slots are provided around the step.

14. The pressure control valve of claim 1, wherein the valve coupling groove is a valve coupling groove of a regulator, and wherein the regulator comprises hydrogen.

15. A hydrogen storage system comprising:
a regulator; and
a pressure control valve, the pressure control valve comprising:
a valve body coupled to a valve coupling groove to be separable;
a first gasket installed at a center portion of a front surface of the valve body, wherein the first gasket is configured to seal or unseal a pressurized gas passageway; and
a second gasket provided on an outer surface of the valve body and pressed against an inner peripheral surface of the pressurized gas passageway.
